(19) United States
(12) Patent Application Publication
(10) Pub. No.: US 2009/0252020 A1
(43) Pub. Date: Oct. 8, 2009

(54) OPTICAL PICKUP

(76) Inventors: Yasuo Ueda, Osaka (JP); Kosuke Takahashi, Osaka (JP); Hiroaki Takahashi, Osaka (JP); Takeomi Ban, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/092,714

(22) PCT Filed: Nov. 7, 2006
(86) PCT No.: PCT/JP2006/322176

§ 371 Date: May 6, 2008

(30) Foreign Application Priority Data
Nov. 8, 2005 (JP) 2005-323211

(51) Int. Cl. G11B 7/135

(52) U.S. Cl. 369/112.23; G9B/7.112

(57) ABSTRACT

An optical pickup according to the present invention includes: an objective lens 1 for converging laser light onto a signal plane of an optical disc 14; a lens actuator 3, 4, 5 capable of moving the objective lens 1 in a direction at least perpendicular to the signal plane of the optical disc 14; and an actuator base 8 for supporting the lens actuator 3, 4, 5. This optical pickup further includes: an adjustment mechanism 10a, 10b, etc., for defining a height of the actuator base 8 within the optical pickup and defining a tilting angle of the actuator base 8 along a tangential direction 15 of the optical disc 14; and a tilt generating mechanism 6a, 6b, 6c, 6d for changing a tilting angle of the objective lens along a radial direction of the optical disc according to a height of the objective lens 1 relative to the actuator base 8.

### TECHNICAL FIELD

The present invention relates to an optical pickup for performing recording/reproduction on or from an information storage medium by irradiating the information storage medium, e.g., an optical disc, with a light beam such as laser light.

### BACKGROUND ART

In an optical disc apparatus, in order to optically record data onto a rotating optical disc, or optically read data from a rotating optical disc, it is necessary to radiate a light beam onto a target track on the optical disc. The radiation of a light beam is performed by using a small “optical pickup” which includes a light source and a photodetection device in itself.

An optical pickup is a component part of an optical disc apparatus which is capable of linearly reciprocating along a radial direction of an optical disc that is set on a disc motor within the optical disc apparatus, and accessing an arbitrary track on the optical disc.

The optical pickup includes: a semiconductor laser as a light source for emitting a light beam; an objective lens for converging onto an optical disc a light beam which is emitted from a semiconductor laser; and an actuator capable of changing the position of the objective lens in accordance with a driving signal from a control section.

Note that the optical pickup also includes a photodetection device for receiving the light beam which is reflected from the optical disc and transmitted through the objective lens. Based on the light beam (reflected light) entering its light-receiving region, the photodetection device is able to generate various electrical signals, such as a reproduction signal, a focus error signal, and a tracking error signal. These electrical signals are sent from the optical pickup into the optical disc apparatus, to integrated circuits such as a front-end processor.

The optical pickup operates while being attached to an optical pickup transport table (traverse device) which is within the optical disc apparatus, and the movement of the optical disc along a radial direction is achieved by the traverse device. As described above, the position of the objective lens within the optical pickup is controlled highly precisely by the actuator within the optical pickup.

Control of the objective lens position during a recording/reproduction operation of the optical disc apparatus is dynamically performed by the traverse device and the actuator within the optical pickup. However, an initial alignment is to be performed mainly by hand during manufacture at the factory. In order to perform such an alignment, it is necessary to adjust a tilt of the objective lens so that the optical axis of the objective lens lies normal to the optical disc.

Tilt adjustment techniques for an objective lens in an optical pickup are disclosed in Patent Document 1 and Patent Document 2, for example. The tilt adjustment techniques disclosed in these documents adopt, in performing an initial alignment, a spherical sliding approach to change the tilt of the objective lens while maintaining a substantially constant center position of the objective lens.

Hereinafter, with reference to FIG. 9, the construction of a conventional optical pickup and tilt adjustments for an objective lens will be described. FIG. 9 is an exploded perspective view for describing a conventional optical pickup.

First, the construction of the optical pickup shown in FIG. 9 will be described. An objective lens 101 included in this optical pickup acts to converge laser light, which is emitted from a light source, onto a signal plane of an optical disc 114. The objective lens 101 is held by a lens holder 102, with a focus coil 103 and a tracking coil 104 being wound around the lens holder 102.

Magnets 105 are placed at opposing positions from the focus coil 103 and the tracking coil 104, so that magnetic fluxes created by the magnets 105 will run across the focus coil 103 and the tracking coil 104. Therefore, when currents flow through the focus coil 103 and the tracking coil 104, the lens holder 102 makes a displacement due to Lorentz force. A force acting on the focus coil 103 and a force acting on the tracking coil 104 can be controlled by the currents flowing through the respective coils. Specifically, by controlling the current flowing through the focus coil 103, the objective lens 101 can be displaced along a focus direction (i.e., a direction perpendicular to a signal plane of the optical disc). On the other hand, by controlling the current flowing through the tracking coil 104, the objective lens 101 can be displaced along a tracking direction (i.e., a radial direction of the optical disc).

One end of each of suspension wires 106a, 106b, 106c, and 106d holds the lens holder 102 so as to be capable of displacement along the aforementioned two orthogonal directions, and also has the function of supplying currents to the focus coil 103 and the tracking coil 104. A suspension holder 107 holds the other end of each of the suspension wires 106a, 106b, 106c, and 106d.

The actuator base 108 retains the magnets 105 and the suspension holder 107. Screw holes 108a1, 108a2, and 108a3 are provided in the actuator base 108. On the bottom face of the actuator base 108, a spherical surface 108b for spherical sliding is formed.

The optical base 109 is a member for retaining optical components (not shown) such as a light source and a photodetection device. Holes 109a1, 109a2, and 109a3 are provided in the optical base 109, at opposing positions from the screw holes 108a1, 108a2, and 108a3 in the actuator base 108. Moreover, a spherical surface 109b for receiving the spherical surface 108b of the actuator base 108 is provided on the optical base 109.

The actuator base 108 is coupled to the optical base 109 in such a manner that the spherical surface 108b thereof slidably abuts with the spherical surface 109b of the optical base. This coupling is established by means of adjustment screws 110a and 110b and a pressurizing screw 111.

Adjustment springs 112a and 112b are attached in a space interposed between the upper face of the optical base 109 and the lower face of the actuator base 108. Moreover, a pressurizing spring 113 is attached in a space interposed between the lower face of the optical base 109 and the screw head of the pressurizing screw 111.

Two adjustment screws 110a and 110b respectively extend through circular air cores of the adjustment springs 112a and 112b. On the other hand, the pressurizing screw 111 extends through a circular air core of the pressurizing spring 113. The adjustment screws 110a and 110b and the pressurizing screw 111 penetrate through the holes 109a1, 109a2, and 109a3 of the optical base 109. Moreover, the adjustment screws 110a and 110b and the pressurizing screw 111 are screwed into the screw holes 108a1, 108a2, and 108a3 of the actuator base 108, respectively.

Note that, at a position on the optical disc 114 where a light beam spot is created, the optical disc will be moving in a tangential direction 115. A radial direction 116 is a direction extending perpendicular to the tangential direction 115. Usually, spiral information tracks are formed on the optical disc 114. During operation of the optical disc apparatus, the objective lens 1 is driven so that a light beam spot which is created on the signal plane of the rotating optical disc will track along a desired information track.

Next, a tilt adjustment method for the objective lens 101 will be described.

As has already been described, the actuator including the objective lens 101 is coupled in such a manner that the spherical surface 108b of the actuator base 108 slidably abuts with the spherical surface 109b of the optical base 109. This coupling is established by means of the adjustment screws 110a and 110b and the pressurizing screw 111. The portion of the actuator base 108 where the screw hole 108a3 is located is pulled down by the pressurizing spring 113, while the actuator base 108 is pressed up by the adjustment springs 112a and 112b.

The adjustment screw 110a is used to perform a tilt adjustment for the objective lens 101 along the tangential direction 115 of the optical disc 114. When the adjustment screw 110a is loosened, the actuator base 108 pivots on the spherical surface 108b by the action of the pressurizing spring 113, so that the vicinity of the screw hole 108a1 of the actuator base 108 is raised. On the other hand, when the adjustment screw 110a is tightened, the actuator base 108 pivots in the opposite direction on the spherical surface 108b, so that the vicinity of the screw hole 108a1 of the actuator base 108 is lowered. Thus, by using the adjustment screw 110a, a tilt adjustment for the objective lens 101 along the tangential direction 115 becomes possible.

The adjustment screw 110b is used to perform a tilt adjustment for the objective lens 101 along the radial direction 116 of the optical disc 114. When the adjustment screw 110b is loosened, the actuator base 108 pivots on the spherical surface 108b by the action of the adjustment spring 112b, so that the vicinity of the screw hole 108a2 of the actuator base 108 is raised. On the other hand, when the adjustment screw 110b is tightened, the actuator base 108 pivots on the spherical surface 108b so that the vicinity of the screw hole 108a2 of the actuator base 108 is lowered. Thus, by using the adjustment screw 110b, a tilt adjustment for the objective lens 101 along the radial direction 116 becomes possible.

### [Patent Document 1] Japanese Laid-Open Patent Publication No. 59-223954

### [Patent Document 2] Japanese Laid-Open Patent Publication No. 2-132642

### DISCLOSURE OF INVENTION

### Problems to be Solved by the Invention

In the conventional optical pickup shown in FIG. 9, in order to adjust the tilt of the objective lens 101 with respect to the optical disc 114, it is necessary to perform tilt adjustments along two axial directions, that is, the tangential direction 115 and the radial direction 116. Therefore, the adjustment screw 110a is provided at a position which is distant along the tangential direction 115 from the objective lens 101, and the adjustment screw 110b is provided at a position which is distant along the radial direction 116 from the objective lens 101, making it necessary to provide two screw holes in the actuator base 108 into which the screws 110a and 110b are screwed. This results in the need for spaces for accommodating such screw holes, thus hindering downsizing of the optical pickup.

The need for the adjustment screws 110a and 110b and the screw holes 108b1 and 108b2 in the actuator base would be eliminated in the case of employing a separate jig other than the optical pickup to perform tilt adjustments for the objective lens 101, instead of using the two adjustment screws 110a and 110b. However, a mechanism which is capable of tilt adjustments along the two axes of the tangential direction 115 and the radial direction 116 would be separately required.

The present invention has been made in order to solve the aforementioned problems, and an objective thereof is to provide an optical pickup which allows for simple tilt adjustments for an objective lens and which is easy to downsize.

### Means for Solving the Problems

An optical pickup according to the present invention is an optical pickup comprising: an objective lens for converging laser light onto a signal plane of an optical disc; a lens actuator capable of moving the objective lens in a direction at least perpendicular to at least the signal plane of the optical disc; and an actuator base; the optical pickup further comprising: an adjustment mechanism for defining a height of the actuator base within the optical pickup and defining a tilting angle of the actuator base along a tangential direction of the optical disc; and a tilt generating mechanism for changing a tilting angle of the objective lens along a radial direction of the optical disc according to a height of the objective lens relative to the actuator base.

In a preferred embodiment, the tilt generating mechanism comprises a plurality of elastic members for elastically coupling the objective lens to the actuator base; and when the objective lens is moved by the lens actuator in a direction substantially perpendicular to the actuator base, the plurality of elastic members elastically deform so that an amount of move of a portion of the objective lens located at an inner periphery side of the optical disc is smaller than an amount of move of a portion located at an outer periphery side of the optical disc.

In a preferred embodiment, the plurality of elastic members include a first elastic member which is coupled to the objective lens at the inner periphery side of the optical disc and a second elastic member which is coupled to the objective lens at the outer periphery side of the optical disc; and the second elastic member has an elastic compliance which is greater than an elastic compliance of the first elastic member and is more likely to deform.

In a preferred embodiment, the adjustment mechanism includes an optical base for supporting the actuator base and two adjustment members for defining a distance of the actuator base relative to the optical base; and the two adjustment members are both located along a line which is parallel to the tangential direction of the optical disc, and couple the actuator base and the optical base to each other.

An adjustment method for an optical pickup according to the present invention is an adjustment method for any of the aforementioned optical pickups, comprising: a step of maintaining a constant distance from the objective lens to the signal plane of the optical disc; and a step of, in a state where a constant distance from the objective lens to the signal plane of the optical disc is being maintained, changing with the adjustment mechanism the height of the actuator base within the optical pickup, thereby adjusting the tilting angle of the objective lens along the radial direction of the optical disc.

### EFFECTS OF THE INVENTION

With an optical pickup according to the present invention, a tilt adjustment for an objective lens along a radial direction can be realized with a simple construction. Thus, downsizing of the optical pickup is possible.

### BRIEF DESCRIPTION OF DRAWINGS

FIG. 1 (a) is an upper plan view of an optical pickup according to the present embodiment; (b) is a side view as seen from a direction which is parallel to line C-C′ in (a); and (c) is a cross-sectional view along line C-C′ in (a).

FIG. 2 An exploded perspective view of an optical pickup according to a first embodiment of the present invention.

FIG. 3 (a) is a diagram showing a state in which an optical axis of an objective lens 1 is perpendicular to an actuator base 8; (b) is a diagram showing a state where the objective lens 1 is raised due to a magnetic force; (c) is a diagram showing the same state as in (a); and (d) is a diagram showing a state where the objective lens 1 is lowered due to a magnetic force.

FIG. 4 (a) is a diagram showing a state in which the optical axis of the objective lens 1 is perpendicular to the actuator base 8; (b) is a diagram showing a state where, in order to maintain the objective lens 1 at a constant height, the actuator base 8 has been lowered while raising the objective lens 1 relative to the actuator base 8.

FIG. 5 Side views of a movable section for describing a tilt generating mechanism according to the present embodiment.

FIG. 6 Side views of the movable section for describing a tilt adjustment along a radial direction according to the present embodiment.

FIG. 7 A flowchart showing a tilt adjustment method according to the present embodiment.

FIG. 8 A flowchart showing another tilt adjustment method according to the present embodiment.

FIG. 9 A exploded perspective view of a conventional optical pickup.

### DESCRIPTION OF THE REFERENCE NUMERALS

1 objective lens
2 lens holder
3 focus coil
4 tracking coil
5 magnet
6a, 6b, 6c, 6d suspension wire
7 suspension holder
8 actuator base
9 optical base

### BEST MODE FOR CARRYING OUT THE INVENTION

### Embodiment 1

Hereinafter, with reference to the drawings, an embodiment of an optical pickup according to the present invention will be described.

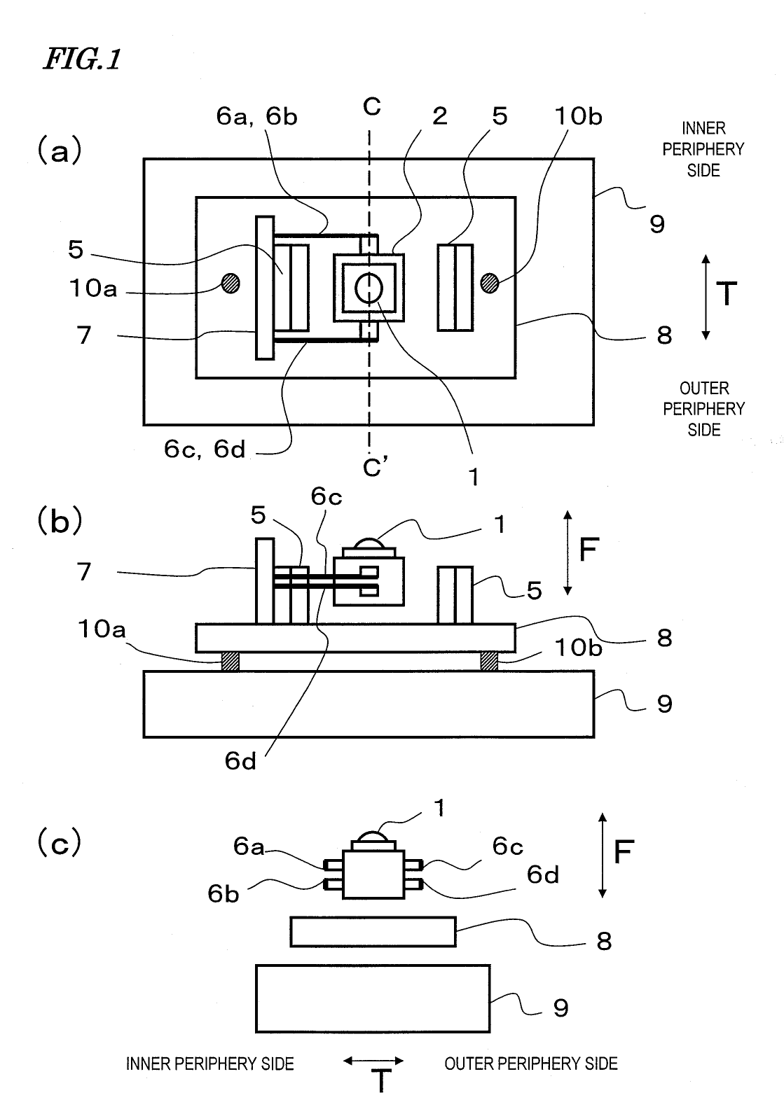

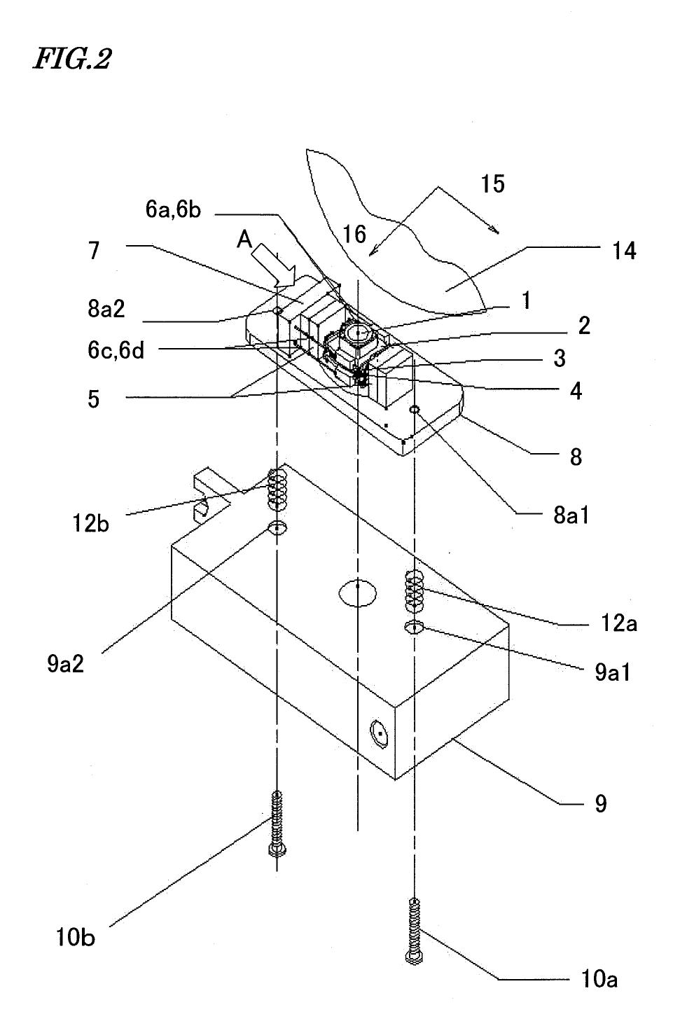

First, FIG. 1 and FIG. 2 will be referred to. FIG. 1(a) is an upper plan view of an optical pickup of the present embodiment; FIG. 1(b) is a side view as seen from a direction which is parallel to line C-C′ in FIG. 1(a); and FIG. 1(c) is a cross-sectional view along line C-C′ in FIG. 1(a). FIG. 2 is an exploded perspective view of the optical pickup of the present embodiment.

The optical pickup shown in FIG. 1 includes: an actuator base 8; and an objective lens 1 which is supported by the actuator base 8 via four suspension wires 6a, 6b, 6c, and 6d. Owing to a lens driving mechanism (lens actuator) described later, the objective lens 1 is capable of displacement in perpendicular/horizontal directions relative to the actuator base 8, against elastic forces of the suspension wires 6a, 6b, 6c, and 6d. Such displacement of the objective lens 1 takes place in accordance with an instruction from a control section within the optical disc apparatus, during recording/reproduction by the optical disc apparatus. Therefore, the objective lens 1 and any portion that moves together with the objective lens 1 may be collectively referred to as a “movable section”. The relative positioning (e.g., height and tilt) of the “movable section” relative to the actuator base 8 is controlled by the action of the lens actuator during operation of the optical disc apparatus.

As shown in FIG. 2, the lens actuator of the present embodiment is composed of: a focus coil 3 and a tracking coil 4 which are wound around the lens holder 2 for holding the objective lens 1; and magnets 5 which are placed at opposing positions from the focus coil 3 and the tracking coil 4.

Since the magnetic fluxes created by the magnets 5 run across the focus coil 3 and the tracking coil 4, when currents flow through the focus coil 3 and the tracking coil 4, the lens holder 2 makes a displacement due to Lorentz force. As described earlier, by controlling the current flowing through the focus coil 3, the magnitude and/or direction of a force which is applied to the objective lens 1 along a focus direction F (i.e., a direction which is perpendicular to the signal plane of the optical disc 14 shown in FIG. 2) can be adjusted. Similarly, by controlling a current flowing through the tracking coil 4, the magnitude and direction of a force which is applied to the objective lens 1 along a tracking direction T (i.e., a radial direction of the optical disc 14 in FIG. 2) can be adjusted.

One end of each of the suspension wires 6a, 6b, 6c, and 6d supports the lens holder 2, whereas the other end of each of the suspension wires 6a, 6b, 6c, and 6d is fixed to the suspension holder 7. The suspension holder 7 is fixed to the actuator base 8. Because the suspension wires 6a, 6b, 6c, and 6d have elasticity, when an external force is acted on the lens holder 2 by the lens actuator as mentioned above, the suspension wires 6a, 6b, 6c, and 6d elastically deform in the manner of cantilevers, thus allowing the lens holder 2 to be displaced along two orthogonal axial directions (i.e., the focus direction F and the tracking direction T). The suspension wires 6a, 6b, 6c, and 6d are made of an electrically conductive material such as a metal, and have the function of supplying currents to the focus coil 3 and the tracking coil 4.

The actuator base 8 having the objective lens 1 and the lens actuator mentioned above is retained by an optical base 9 which supports optical components (not shown) such as a light source (semiconductor laser) and a photodetector (optical/electrical converter). The actuator base 8 and the optical base 9 are coupled via adjustment screws 10a and 10b. As will be described later, the relative positioning of the actuator base 8 and the optical base 9 can be adjusted with the adjustment screws 10a and 10b. However, the relative positioning of the actuator base 8 with respect to the optical base 9 is fixed during manufacture of the optical pickup at the factory, and will not be readjusted during an operation of the optical disc apparatus.

The optical base 9 is attached to a housing (not shown) of the optical pickup, and when in use, the optical pickup is attached to a traverse device (not shown) of the optical disc apparatus. This traverse device is a device for moving the optical pickup itself in a linear manner along a radial direction of the optical disc, in order to move the position, from the innermost periphery to the outermost periphery of the optical disc, of a light spot which a light beam emitted from the optical pickup creates on the signal plane of the optical disc.

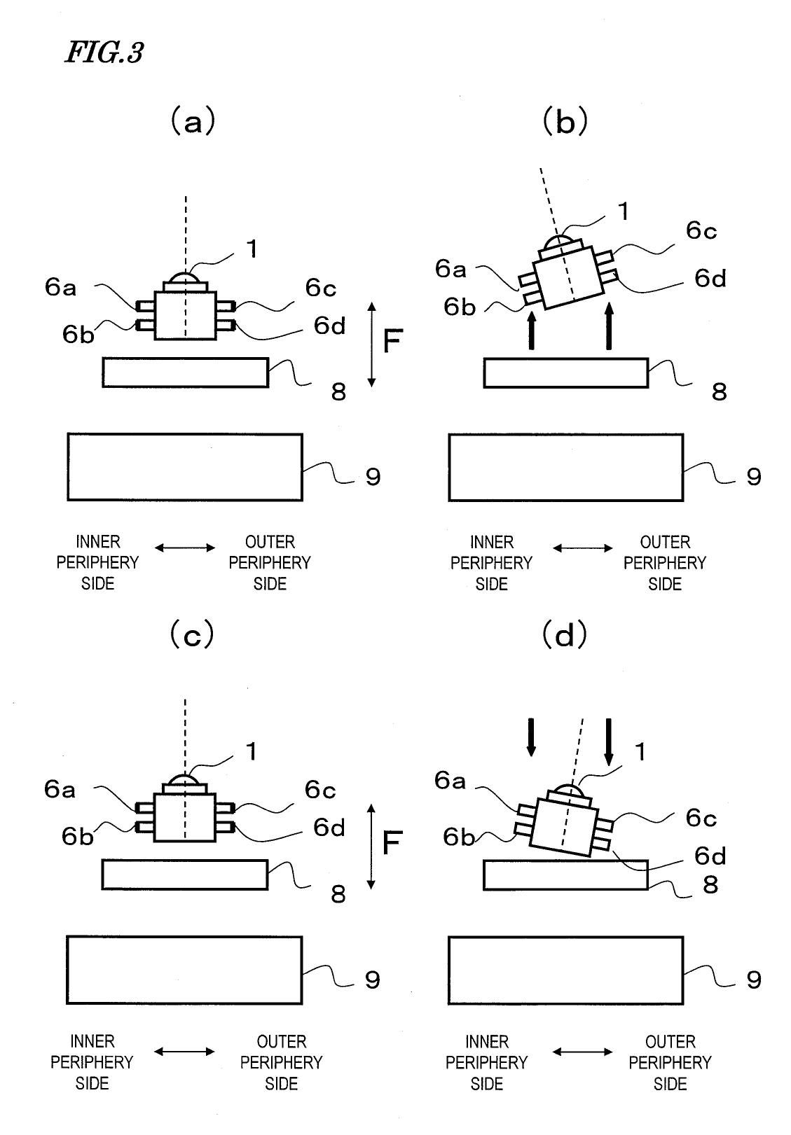

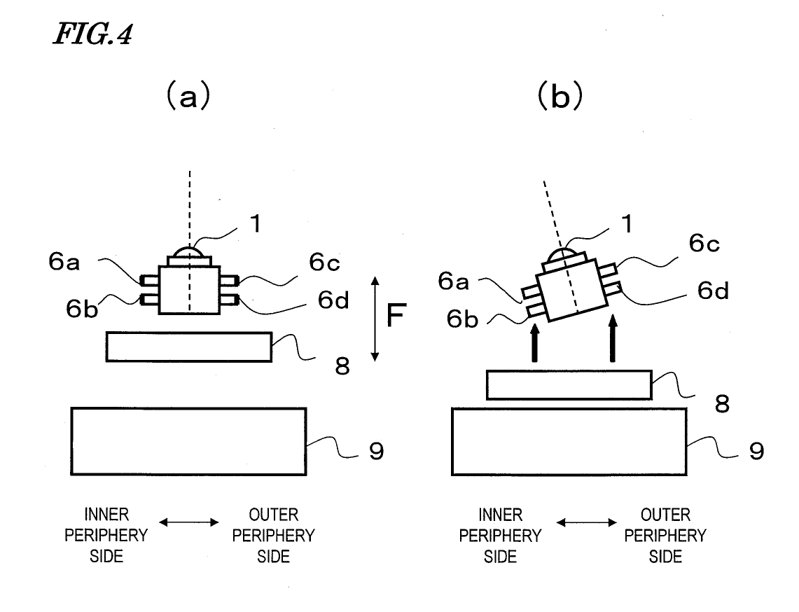

In the present embodiment, among the four suspension wires 6a, 6b, 6c, and 6d, “elastic compliance” differs between the suspension wires 6c and 6d which are located at the outer periphery side of the optical disc 14 (FIG. 2) and the suspension wires 6a and 6b which are located at the inner periphery side. Elastic compliance is a parameter indicating a readiness of an elastic member to deform, which is in inverse proportion to the spring modulus. In the present embodiment, the elastic compliance of the suspension wires 6c and 6d located at the outer periphery side of the optical disc 14 is set to be a greater value than the elastic compliance of the suspension wires 6a and 6b located at the inner periphery side. As a result, when the distance from the actuator base 8 to the objective lens 1 is increased or decreased by the action of the lens actuator, the tilt of the objective lens 1 along the radial direction 16 of the optical disc 14 can be changed. Hereinafter, this will be specifically described with reference to FIG. 3 and FIG. 4.

First, FIGS. 3(a) to (d) will be referred to. FIG. 3(a) shows a state in which the optical axis of the objective lens 1 is perpendicular to the actuator base 8. FIG. 3(b) shows a state in which the objective lens 1 is raised due to a magnetic force. In this state, the upper face of the objective lens 1 is tilted in a direction toward the inner periphery side, as shown in FIG. 3(b), because the suspension wires 6c and 6d at the outer periphery side are more likely to deform than the suspension wires 6a and 6b at the inner periphery side.

FIG. 3(c) shows the same state as in FIG. 3(a); and FIG. 3(d) shows a state where the objective lens 1 is lowered due to a magnetic force. In this state, the upper face of the objective lens 1 is tilted in a direction toward the outer periphery side, as shown in FIG. 3(d), because the suspension wires 6c and 6d at the outer periphery side are more likely to deform than the suspension wires 6a and 6b at the inner periphery side.

Thus, in the present embodiment, when the objective lens 1 is moved up or down by using the lens driving mechanism (lens actuator), the tilt angle of the objective lens 1 can be controlled by the action of the suspension wires 6a, 6b, 6c, and 6d. Stated otherwise, in the present embodiment, the suspension wires 6a, 6b, 6c, and 6d function as a “tilt generating mechanism” according to the present invention.

Next, with reference to FIGS. 4(a) and (b), the operation of this “tilt generating mechanism” will be described further more specifically. FIG. 4(a) is an identical drawing to FIG. 3(a). FIG. 4(b) is a diagram showing a state where the actuator base 8 has been lowered while raising the objective lens 1 relative to the actuator base 8. The method of lowering the actuator base 8 will be described later.

In FIG. 4(b), the height of the central portion of the objective lens 1 itself is maintained equal to the height of the central portion of the objective lens 1 as shown in FIG. 4(a) (i.e., the interval between the optical disc and the objective lens being kept constant by the action of focus servo). However, since an external force (magnetic force) to pull away from the actuator base 8 is working on the objective lens 1, the objective lens 1 is tilted as in the example shown in FIG. 3(b). Thus, what defines the tilt of the objective lens 1 is not the absolute height of the objective lens 1, but is the distance from the actuator base 8 to the objective lens 1. Note that, if the actuator base 8 is raised while maintaining the central portion of the objective lens 1 at a constant height, the objective lens 1 will be tilted in a direction similar to the example shown in FIG. 3(d).

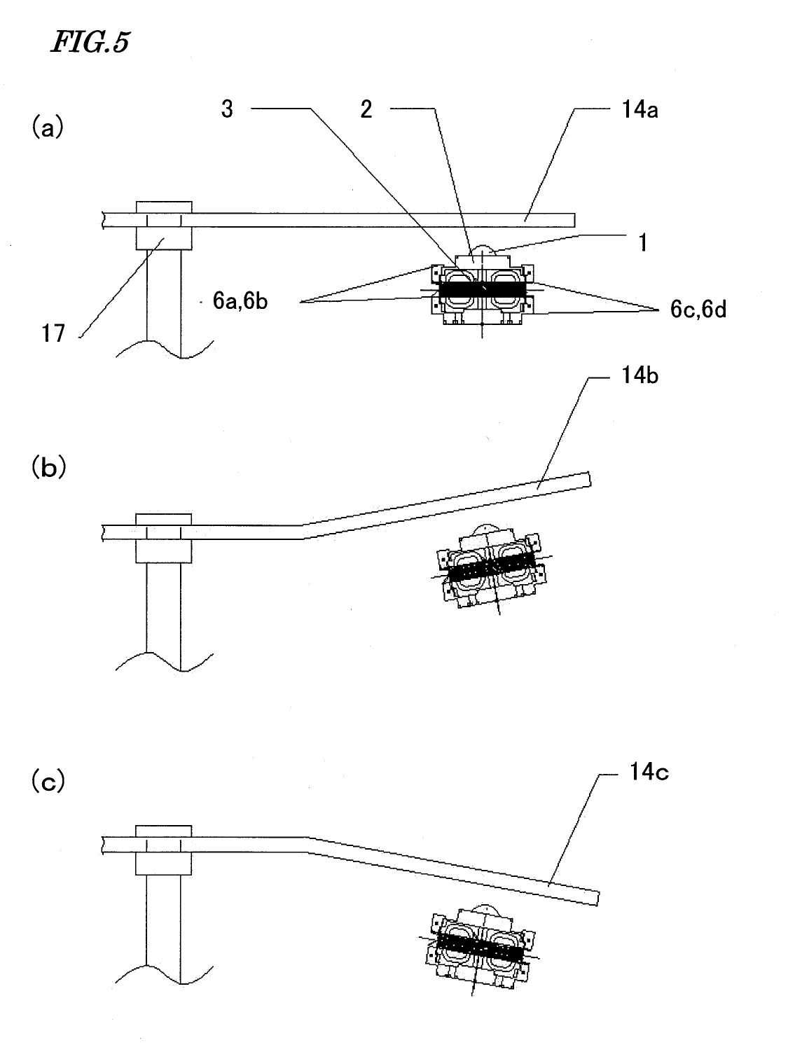

Next, with reference to FIGS. 5(a) to (c), it will be described how the tilt generating mechanism operates in response to a warp of an optical disc. FIG. 5 shows the movable section including the objective lens 1 as seen from arrow A in FIG. 2, as well as a partial side view of the optical disc 14, and also shows a turntable 17 for rotating the optical disc 14. Of the optical disc 14 having been set on the turntable 17, positions closer to the turntable 17 correspond to the inner periphery side of the optical disc 14, whereas positions closer to the outer periphery edge of the optical disc 14 correspond to the outer periphery side.

FIG. 5(a) shows the movable section including the objective lens 1 during reproduction from an optical disc 14a which has little warp. Since focus servo control is in an ON state, the point of convergence of a light beam transmitted through the objective lens 1 always rests upon the signal plane of the optical disc 14a. In this state, it is assumed that adjustments using the adjustment screws 10a and 10b have been completed in advance so that the optical axis of the objective lens 1 lies perpendicular to the signal plane of the optical disc 14a.

FIG. 5(b) shows an optical disc 14b having an upward warp and the movable section including the objective lens 1, during reproduction from the optical disc 14b. Generally speaking, an optical disc which is warped tends to have a large amount of deformation at its outer periphery side, thus being deformed into a dish shape having a concave or convex central portion. During reproduction of such an optical disc 14b, the distance between the objective lens 1 and the optical disc is also kept constant by the action of focus servo control. In other words, by the action of the lens actuator under servo control, the objective lens 1 is raised from the position of FIG. 5(a). The distance of such a rise of the objective lens 1 corresponds to the magnitude of upward warp of the optical disc 14b. In the present embodiment, since the suspension wires 6a and 6b located at the inner periphery side of the optical disc have a smaller elastic compliance than the elastic compliance of the suspension wires 6c and 6d located at the outer periphery side, when the objective lens 1 is raised relative to FIG. 5(a), the objective lens 1 will be tilted so that its inner periphery side lowers as shown in FIG. 3(b). The direction of this tilt is identical to the direction of the warp of the optical disc 14b, which makes it possible to reduce the relative tilt with respect to the optical disc 14b having an upward warp.

On the other hand, FIG. 5(c) shows an optical disc 14c having a downward warp and the movable section including the objective lens 1, during reproduction from the optical disc 14c. When the objective lens 1 is lowered from the position shown in FIG. 5(a), due to the difference in elastic compliance between the suspension wires 6a and 6b at the inner periphery side and the suspension wires 6c and 6d at the outer periphery side, the objective lens 1 will be tilted as shown in FIG. 3(d). This makes it possible to reduce the relative tilt with respect to the optical disc 14b having a downward warp.

Thus, by ensuring that the elastic compliance of the suspension wires 6a and 6b at the inner periphery side is smaller than the elastic compliance of the suspension wires 6c and 6d at the outer periphery side, it becomes possible to allow the objective lens 1 to be tilted in the same direction as the warp of the optical disc 14 with the going up or down of the objective lens 1, thus improving the reproduction performance with respect to a warped disc.

The height of the signal plane of a warped optical disc which is mounted on the optical disc apparatus may differ about 0.5 mm from the signal plane of an unwarped optical disc, for example, and its warp angle may be about 0.2 to 0.3°. Therefore, the optical axis of the objective lens 1 may be tilted by about 0.2 to 0.3° when the height at the central portion of the objective lens 1 is moved up or down by about 0.5 mm, for example. Such a tilt can be realized by prescribing an about 5 to 6% difference in elastic compliance between the suspension wires 6a and 6b at the inner periphery side and the suspension wires 6c and 6d at the outer periphery side.

In order to provide the aforementioned difference in elastic compliance between the suspension wires 6a and 6b at the inner periphery side and the suspension wires 6c and 6d at the outer periphery side, for example, the suspension wires 6c and 6d may be formed from a material whose elastic modulus is smaller than the elastic modulus of the material of the suspension wires 6a and 6b. Alternatively, in the case where the suspension wire suspension wires 6a, 6b, 6c, and 6d are made of the same material, the diameter of the suspension wires 6c and 6d may be made smaller than the diameter of the suspension wires 6a and 6b.

What is most characteristic of the optical pickup of the present embodiment having the aforementioned construction is the coupling structure between the optical base 9 and the actuator base 8. By utilizing this coupling structure, an initial alignment of the optical pickup can be facilitated.

Hereinafter, referring back to FIG. 2, this coupling structure will be specifically described.

As described above, the actuator base 8 is coupled to the optical base 9 by the adjustment screws 10a and 10b. More specifically, two screw holes 8a1 and 8a2 are provided in the actuator base 8, and holes 9a1 and 9a2 are provided in the optical base 9 at opposing positions from the screw holes 8a1 and 8a2 in the actuator base 8. Adjustment springs 12a and 12b are attached in a space interposed between the upper face of the optical base 9 and the lower face of the actuator base 8. The two adjustment screws 10a and 10b, which respectively extend through the circular air cores of the adjustment springs 12a and 12b, penetrate through the holes 9a1 and 9a2 in the optical base so as to be screwed into the screw holes 8a1 and 8a2 of the actuator base. The adjustment screws 10a and 10b are positioned at substantially equal distances along the tangential direction 15 from the center of the objective lens 1.

The above-described construction functions as an “alignment mechanism” for adjusting the relative positioning of the actuator base 8 with respect to the optical base 9, defines an interval between the optical base 9 and the actuator base 8, and is also able to define a tilting angle of the actuator base 8 with respect to the optical base 9 along the tangential direction 15 of the optical disc 14.

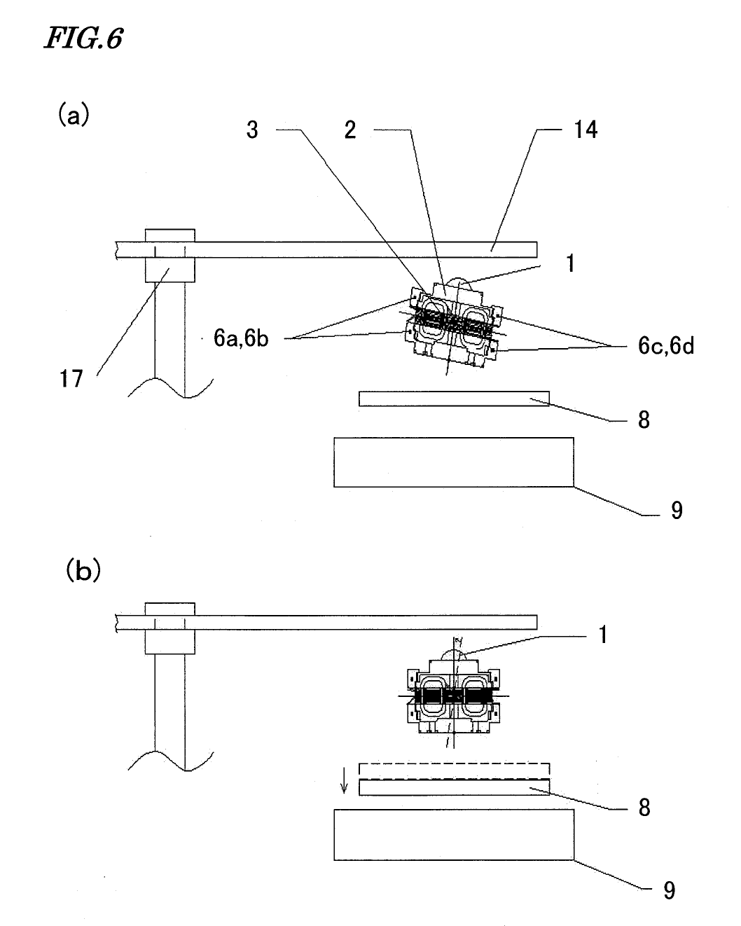

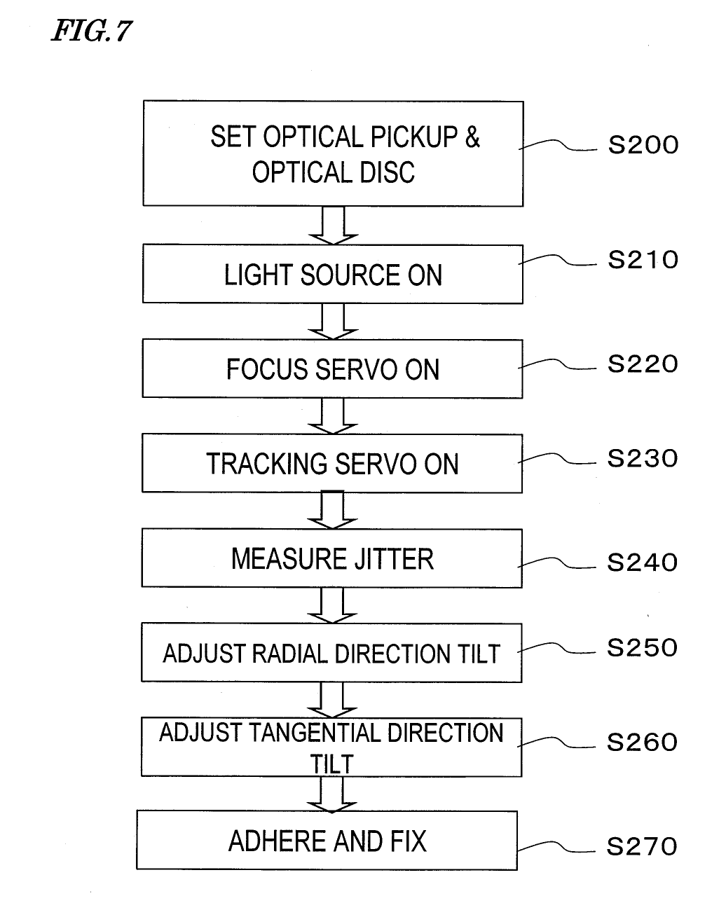

Next, with reference to FIG. 6 and FIG. 7, an initial tilt adjustment method for the objective lens 1 will be described. FIG. 6 is a diagram for describing a tilt adjustment for the objective lens 1 along the radial direction 16 of the optical disc 14, showing the movable section as seen from the direction of arrow A in FIG. 2. FIG. 7 is a flowchart showing an adjustment procedure.

First, at step S200 shown in FIG. 7, an optical disc and the optical pickup of the present embodiment are set as shown in FIG. 6(a). Thereafter, at step S210, the light source of the optical pickup is driven into an ON state, and a light beam is emitted from the light source so as to form a light beam spot on a signal plane of the optical disc. Next, after focus control is turned ON at step S220, tracking control is turned ON at step S230. At this time, since focus servo control is at work, the lens actuator operates so that a point of convergence of the light beam having been transmitted through the objective lens 1 is located on the signal plane of the optical disc 14. As a result, the distance from the surface of the optical disc 14 to the objective lens 1 is controlled to be constant. Herein, in the example shown in FIG. 6(a), it is assumed that the optical axis of the objective lens 1 is tilted with respect to the signal plane of the unwarped optical disc 14.

Next, in a state where focus servo control and tracking control are at work, light which is reflected from the signal plane of the rotating optical disc is detected with a photodetector in the optical pickup, and a jitter of the reproduction signal is measured (step S240).

Next, at step S250, a radial direction tilt is adjusted so that as to minimize the jitter. In the example shown in FIG. 6(a), the outer periphery side of the objective lens 1 is lower than the inner periphery side. Therefore, the actuator base 8 is lowered as shown in FIG. 6(b). At this time, too, by the action of focus servo control, the lens actuator operates so that a point of convergence of the light beam having been transmitted through the objective lens 1 is located on the signal plane of the optical disc 14. Therefore, even during the lowering of the actuator base 8, the distance from the surface of the optical disc 14 to the objective lens 1 is controlled to be constant. In other words, the center height of the objective lens 1 with respect to the optical base 9 does not change. In this case, since the suspension wires 6a and 6b at the inner periphery side have a smaller elastic compliance than the elastic compliance of the suspension wires 6c and 6d at the outer periphery side, as described earlier, the flexure of the suspension wires 6c and 6d becomes relatively greater with lowering of the actuator base 8, thus causing a change in the posture of the objective lens 1. When the actuator base 8 is lowered by an appropriate distance, as shown in FIG. 6(b), the optical axis of the objective lens 1 becomes perpendicular to the signal plane of the optical disc 14.

In the present embodiment, the lowering distance of the actuator base 8 is adjusted so that the measured value of the jitter becomes minimum. The reason is that the jitter of the reproduction signal should become smaller as the incident angle of the light beam with respect to the signal plane of the optical disc becomes closer to perpendicular. Instead of relying on jitter to adjust the height of the actuator base 8, any other parameter that is available for evaluating the quality of the reproduction signal may be used for adjusting the height of the actuator base 8.

Lowering of the actuator base 8 is performed by an operator who tightens the adjustment screws 10a and 10b shown in FIG. 1 by the same distance. When the adjustment screws 10a and 10b are tightened by the same distance, as shown in FIG. 6(b), the actuator base 8 moves down while maintaining a parallel state.

Thus, when the outer periphery side of the objective lens 1 is lower than the inner periphery side before the adjustment, an adjustment may be made so as to lower the actuator base 8, whereby the unwanted tilt of the objective lens 1 can be corrected. Conversely, when the inner periphery side of the objective lens 1 is lower than the outer periphery side, the adjustment screws 10a and 10b may be loosened to raise the actuator base 8.

Next, at step S260 in FIG. 7, a tilt adjustment along the tangential direction is performed. Specifically, since the two adjustment screws 10a and 10b are located along a line which is parallel to the tangential direction 15 as shown in FIG. 1(b) and FIG. 2, the tilt of the objective lens 1 along the tangential direction 15 can be adjusted with the adjustment screws 10a and 10b. For example, in the case of making an adjustment to allow the side of the objective lens 1 that is closer to the adjustment screw 10a to be lowered relative to the side that is closer to the adjustment screw 10b, the adjustment screw 10a is tightened, and the adjustment screw 10b is loosened by the same amount. This point will be specifically described below.

First, when the adjustment screw 10a located on the left-hand side in FIG. 1(a) is tightened, the left portion of the actuator base 8 is lowered closer to the optical base 9 in FIG. 1(a). By varying the degree of tightening the adjustment screw 10a, it is possible to adjust the lowering distance of the actuator base 8 at its left portion. When the left portion of the actuator base 8 is lowered by tightening the adjustment screw 10a, the central portion of the objective lens 1 also lowers correspondingly. The objective lens 1 in the present embodiment is located in the substantial center between the two adjustment screws 10a and 10b. Therefore, when the adjustment screw 10a is tightened by a distance L mm, for example, the central portion of the objective lens 1 would be lowered by about L/2 mm if focus servo were not in an ON state. However, since focus servo is in an ON state in practice, the height of the central portion of the objective lens 1 relative to the optical base 9 never changes. However, if left at it is, the tilting angle along the radial direction would change because of the broader distance from the actuator base to the objective lens 1. In order to counteract such a change, it is necessary to raise the right portion of the actuator base 8. This rise is achieved by loosing the adjustment screw 10b. By moving the adjustment screw 10a and the adjustment screw 10b by the same distance in opposite directions, its tilt adjustment along the tangential direction 15 can be performed without changing the height of the central portion of the actuator base 8.

In the case of making an adjustment to allow the side of the objective lens 1 that is closer to the adjustment screw 10b to be lowered relative to the side that is closer to the adjustment screw 10a, the adjustment screw 10b is tightened, and the adjustment screw 10a is loosened by the same amount.

Thus, the tilting angle along the tangential direction can be controlled based on the degree of tightening or loosening the adjustment screws 10a and 10b. Thus, by allowing the adjustment screw 10a and the adjustment screw 10b to be moved by the same distance in opposite directions, it is possible to optimize the tilting angle of the actuator base 8 along the tangential direction, and hence the tilting angle of the objective lens 1, without changing the tilting angle of the objective lens 1 along the radial direction.

In the present embodiment, adjustment along the tangential direction is performed in such a manner as to minimize the measured value of jitter. This is because, as mentioned earlier, the jitter of a reproduction signal should become smaller as the incident angle of the light beam with respect to the signal plane of the optical disc becomes closer to perpendicular. Instead of relying on jitter to adjust the tilt of the actuator base along the tangential direction, any other parameter that is available for evaluating the quality of the reproduction signal may be used for adjusting the tilt of the actuator base 8. After the adjustment of the tangential direction tilt is thus completed, the adjustment screws 10a and 10b are fixed with an adhesive (step S270). Note that the order of step S250 and step S260 may be opposite.

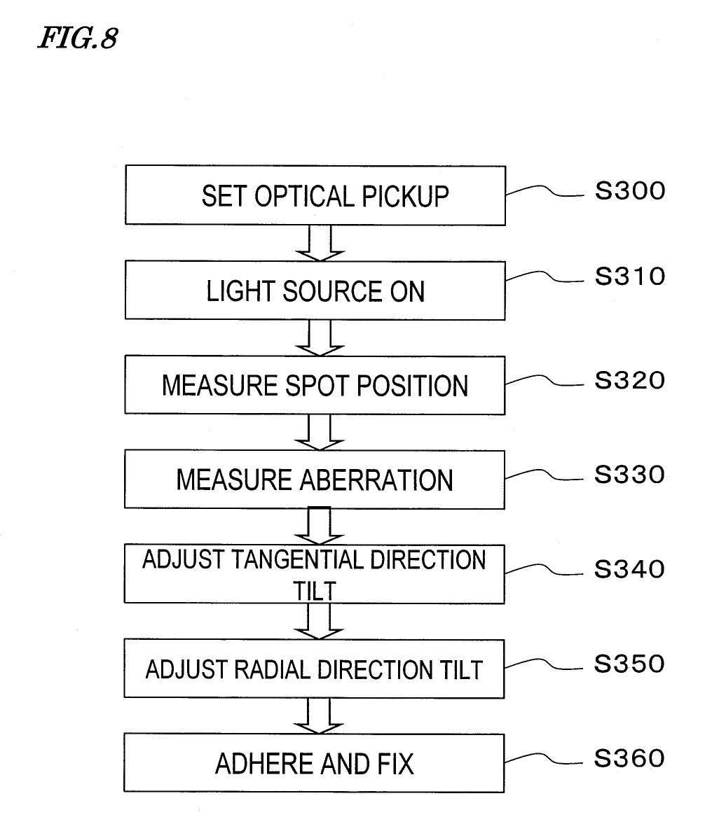

Although jitter is used as an index with which to adjust the tilt of the objective lens 1 in the above-illustrated example, aberration of a light spot which is formed on a signal plane of an optical disc may be used instead of jitter. Hereinafter, an exemplary adjustment using aberration will be described with reference to FIG. 8.

First, after the optical pickup is set at step S300 in FIG. 8, the light source in the optical pickup is driven into an ON state at step S310, and a light beam is emitted from the light source so as to form a light beam spot on a signal plane of the optical disc. At this time, instead of an optical disc, any member may alternatively be used that is identical to an optical disc in terms of base thickness (i.e., distance from the disc surface to the signal plane), refractive index of the base, and the like.

Next, after adjusting the position of the light beam spot which is formed on the signal plane of the optical disc at step S320, a coma aberration is measured with a spot aberration measurement apparatus (step S330).

Now, as shown in FIG. 6(a), it is assumed that the optical axis of the objective lens 1 is tilted with respect to the signal plane of the unwarped optical disc 14. Such a tilt would result in an increase coma aberration of the spot.

Next, the tangential direction tilt is adjusted so as to minimize the coma aberration at step S340, and thereafter the radial direction tilt is adjusted at step S350. Although the “tangential direction tilt” is adjusted before the “radial direction tilt” here, the “radial direction tilt” may in fact be adjusted before the “tangential direction tilt”, as shown in FIG. 7. This order of adjustments may be arbitrary. The tilt adjustment method is as described with reference to the flow of FIG. 7, with a difference being that the adjustment is performed so as to minimize coma aberration, instead of jitter. As for the adjustment along the radial direction, the lens actuator is driven so as to maintain the height of the objective lens corresponding to the ups and downs of the actuator base. For example, when the actuator base is lowered, the objective lens may be raised by an amount equal to lowering.

After completing such adjustments, at step S360, the adjustment screws 10a and 10b are fixed with an adhesive.

Since aberration is measured in the example of FIG. 8, it is not necessary to rotate an optical disc to reproduce a signal. Moreover, the height/tilt of the objective lens 1 is adjusted in such a manner as to minimize aberration, without carrying out focus servo or tracking servo.

As has been described above, according to the present embodiment, since a tilt generating mechanism and a height adjustment mechanism for the objective lens are comprised, an optical pickup is provided which makes it possible to realize tilt adjustments along the two axes of the tangential direction 15 and radial direction 16 in the optical disc apparatus 14, and which has a small projected area.

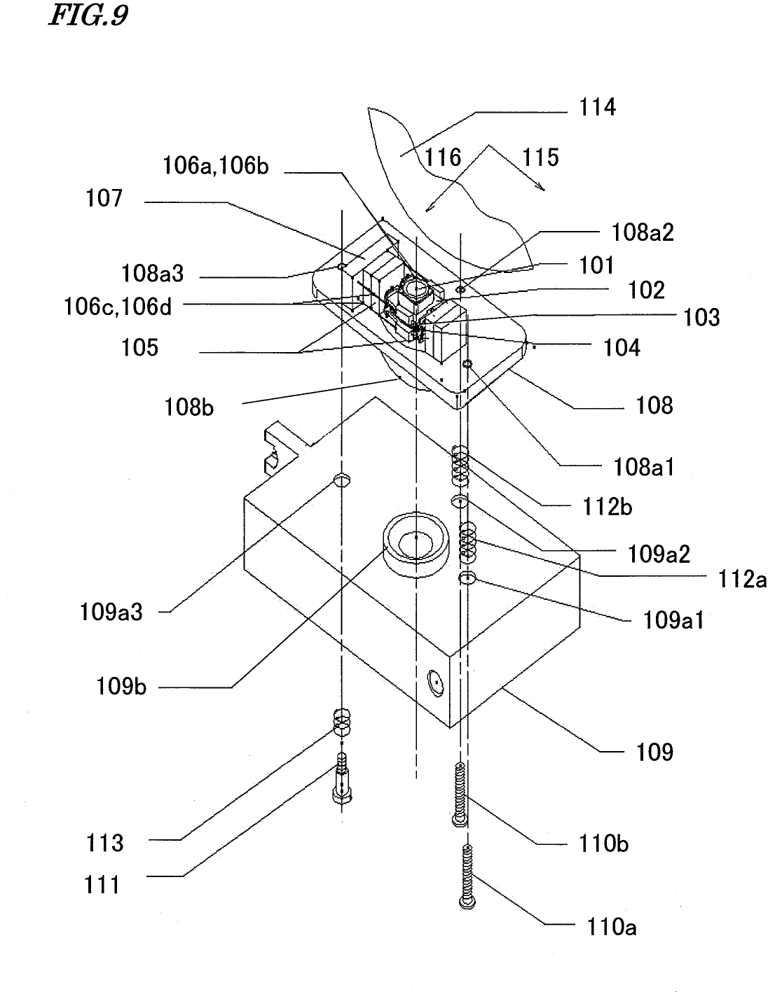

In accordance with the construction of the present embodiment, adjustment screws for the radial direction are eliminated as compared to the optical pickup of FIG. 9, thus making it possible to provide an inexpensive and small optical pickup while retaining similar functions to conventional functions.

Moreover, according to the optical pickup of the present embodiment, as has been described with reference to FIGS. 5(a) to (c), the tilt generating mechanism generates a tilt of the objective lens 1 in accordance with warps of the optical disc, thus resulting in a reduced tilt with respect to the optical disc. As a result, an improved reproduction performance against warps of an optical disc is also obtained.

Although the elastic compliance of the suspension wires is varied between the inner periphery side and the outer periphery side to realize a tilt generating mechanism in the above embodiment, the present invention is not limited to such cases. Any other construction may be adopted that allows the objective lens to be automatically tilted according to the height of the objective lens relative to the actuator base.

Although the objective lens is supported by four suspension wires in the above embodiment, the number of suspension wires is not limited to four. Moreover, in order to vary the bending readiness of the suspension wires between the optical disc inner periphery side and the outer periphery side, either one of the two suspension wires located at the inner periphery side or the outer periphery side may be set to a different thickness or formed from a different material from that of the other suspension wires.

### INDUSTRIAL APPLICABILITY

The optical pickup according to the present invention can be suitably used for various kinds of optical information recording/reproduction apparatuses which perform recording/reproduction on or from an information storage medium by irradiating the information storage medium with a light beam such as laser light.

1. An optical pickup comprising:
an objective lens for converging laser light onto a signal plane of an optical disc;
a lens actuator capable of moving the objective lens in a direction at least perpendicular to at least the signal plane of the optical disc; and
an actuator base;
the optical pickup further comprising:
an adjustment mechanism for defining a height of the actuator base within the optical pickup and defining a tilting angle of the actuator base along a tangential direction of the optical disc; and
a tilt generating mechanism for changing a tilting angle of the objective lens along a radial direction of the optical disc according to a height of the objective lens relative to the actuator base.

2. The optical pickup of claim 1, wherein,
the tilt generating mechanism comprises
a plurality of elastic members for elastically coupling the objective lens to the actuator base; and
when the objective lens is moved by the lens actuator in a direction substantially perpendicular to the actuator base, the plurality of elastic members elastically deform so that an amount of move of a portion of the objective lens located at an inner periphery side of the optical disc is smaller than an amount of move of a portion located at an outer periphery side of the optical disc.

3. The optical pickup of claim 2, wherein,
the plurality of elastic members include a first elastic member which is coupled to the objective lens at the inner periphery side of the optical disc and a second elastic member which is coupled to the objective lens at the outer periphery side of the optical disc; and
the second elastic member has an elastic compliance which is greater than an elastic compliance of the first elastic member and is more likely to deform.

4. The optical pickup of claim 1, wherein,
the adjustment mechanism includes an optical base for supporting the actuator base and two adjustment members for defining a distance of the actuator base relative to the optical base; and
the two adjustment members are both located along a line which is parallel to the tangential direction of the optical disc, and couple the actuator base and the optical base to each other.

5. An adjustment method for the optical pickup of claim 1, comprising:
a step of maintaining a constant distance from the objective lens to the signal plane of the optical disc; and
a step of, in a state where a constant distance from the objective lens to the signal plane of the optical disc is being maintained, changing with the adjustment mechanism the height of the actuator base within the optical pickup, thereby adjusting the tilting angle of the objective lens along the radial direction of the optical disc.
